(19) United States
(12) Patent Application Publication
(10) Pub. No.: US 2025/0384637 A1
(43) Pub. Date: Dec. 18, 2025

(54) METHOD, APPARATUS, AND COMPUTER-READABLE MEDIUM FOR GENERATING A VIEW OF AN AUGMENTED REALITY ENVIRONMENT

(71) Applicant: Fox Sports Productions, LLC, LOS ANGELES, CA (US)

(72) Inventors: Zac Fields, Los Angeles, CA (US); Alex Seflinger, Los Angeles, CA (US); Jim Rodman, LOS ANGELES, CA (US); Hanna Frangiyyeh, Los Angeles, CA (US); Chris Smith, LOS ANGELES, CA (US)

(73) Assignee: Fox Sports Productions, LLC, LOS ANGELES, CA (US)

(21) Appl. No.: 19/238,176

(22) Filed: Jun. 13, 2025

Related U.S. Application Data
(60) Provisional application No. 63/660,243, filed on Jun. 14, 2024.

(51) Int. Cl. G06T 19/00

(52) U.S. Cl. CPC G06T 19/006

(57) ABSTRACT

An apparatus, method, and computer-readable medium for generating a view of an augmented reality environment includes: generating an augmented reality (AR) environment based at least in part on one or more audiovisual feeds of a set captured by one or more physical cameras and one or more three-dimensional graphics models of a virtual environment; tracking a current viewpoint location within the AR environment, the current viewpoint location corresponding to one or more of a physical location of a physical camera in the one or more physical cameras or a virtual location of a virtual camera in the virtual environment; and generating a view of the AR environment based at least in part on the current viewpoint location.

### CROSS-REFERENCE TO RELATED APPLICATIONS

This application claims priority to U.S. Provisional Application 63/660,243, filed Jun. 14, 2024, the entire contents of which are hereby incorporated in full by this reference.

### DESCRIPTION

### Field of the Invention

The present invention relates to a method, a system, and a computer-readable medium for generating a view of an augmented reality environment that enables a 360-degree film set not previously realized.

### Background of the Invention

The utilization of an Augmented Reality (AR) and/or an Extended Reality (XR) film set traditionally limits camera movements to the environment where the subjects are located. While the film sent can be extended to be a 360-degree volumetric AR/XR film set, in order to fly a camera to a larger space requires the merger between a practical camera and a virtual camera. There is a need, for which the inventors have developed, a system to go between the two cameras that utilizes practical camera tracking data and blending of a virtual camera.

Furthermore, some film sets have used a physical LED screen to display an extended reality (XR) background having a limit end at the top of the LED screen and then utilized an augmented reality (AR) extension above the walls. The AR extends the environment beyond the height of the physical LED. However, it is difficult to create a seamless transition between the top of the LED screen and the AR above the screen. Second, there is a need to further extend the environment to all sides of the LED screen in a seamless manner. The Applicant's invention has solved this difficulty.

### SUMMARY OF THE INVENTION

The inventors have developed a method where both the practical (i.e., physical) camera and the virtual camera ingest the same tracking data. Using a “rail” system, it is possible to now transition between the two cameras in a seamless manner. The rails are used as guidelines that show where the virtual camera will fly. There is no limit to the number of rails that can be used in an environment. These rails are predetermined locations and paths. On a user command the practical camera can blend into the virtual camera or vice versa. The virtual camera can then fly around the environment allowing complete use of a 360-degree film set, which was not possible before.

Furthermore, the inventors have created a method for seamlessly extending the background to all 4 sides of the LED screen. This includes above the LED, to both left and right sides and extending the floor plane. These extensions allow for the subjects to be placed in a 360 degree fully immersive environment.

An exemplary embodiment of the present invention is a method executed by one or more computing devices for generating a view of an augmented reality environment, the method comprising: generating, by at least one of the one or more computing devices, an augmented reality (AR) environment based at least in part on one or more audiovisual feeds of a set captured by one or more physical cameras and one or more three-dimensional graphics models of a virtual environment; tracking, by at least one of the one or more computing devices, a current viewpoint location within the AR environment, the current viewpoint location corresponding to one or more of: a physical location of a physical camera in the one or more physical cameras or a virtual location of a virtual camera in the virtual environment; and generating, by at least one of the one or more computing devices, a view of the AR environment based at least in part on the current viewpoint location.

The physical film set may comprise one or more light emitting diode (LED) panels and wherein the one more LED panels are configured to output a portion of the virtual environment based at least in part on the current viewpoint location.

The view of the AR scene may comprise one or more physical objects in the set captured by the physical camera at the physical location and one or more virtual objects visible to the virtual camera at the virtual location in the virtual environment.

The one or more physical objects may comprise the one or more LED panels and wherein the one more LED panels are configured to output a portion of the virtual environment based at least in part on the current viewpoint location.

The view of the AR scene may comprise one or more one or more virtual objects visible to the virtual camera at the virtual location in the virtual environment.

The invention may comprise storing, by at least one of the one or more computing devices, one or more virtual camera pathways, each virtual camera pathway defining a path through at least a portion of the virtual environment.

The invention may comprise receiving, by at least one of the one or more computing devices, a selection of a virtual camera pathway in the one or more virtual camera pathways; and transitioning, by at least one of the one or more computing devices, the current viewpoint location within the AR scene through the path defined by the selected virtual camera pathway.

The view of the AR scene may be generated based on the virtual location of the virtual camera in the virtual environment when transitioning the current viewpoint location within the AR scene through the path defined by the selected virtual camera pathway.

The invention may comprise receiving, by at least one of the one or more computing devices, an instruction to transition from a virtual camera to a physical camera; determining, by at least one of the one or more computing devices, the current viewpoint location at termination of a virtual camera pathway; and selecting, by at least one of the one or more computing devices, a physical camera in the one or more physical cameras based at least in part on the current viewpoint location.

The invention may comprise receiving, by at least one of the one or more computing devices, an instruction to transition from a physical camera to a virtual camera; determining, by at least one of the one or more computing devices, the current viewpoint location based on a physical location of the physical camera; and selecting, by at least one of the one or more computing devices, a virtual camera pathway based at least in part on the current viewpoint location.

The invention may include generating a view of the AR scene based at least in part on the current viewpoint location comprises one of: generating a view based on a portion of the virtual environment visible to the virtual camera; or generating a view based on output from at least one physical camera in the one or more physical cameras and a portion of the portion of the virtual environment visible to the virtual camera.

The current viewpoint location comprises one or more spatial coordinates and one or more orientation vectors.

An exemplary embodiment of the present invention is an apparatus for generating a view of an augmented reality environment, the apparatus comprising: one or more processors; and one or more memories operatively coupled to at least one of the one or more processors and having instructions stored thereon that, when executed by at least one of the one or more processors, cause at least one of the one or more processors to: generate an augmented reality (AR) environment based at least in part on one or more audiovisual feeds of a set captured by one or more physical cameras and one or more three-dimensional graphics models of a virtual environment; track a current viewpoint location within the AR environment, the current viewpoint location corresponding to one or more of: a physical location of a physical camera in the one or more physical cameras or a virtual location of a virtual camera in the virtual environment; and generate a view of the AR environment based at least in part on the current viewpoint location.

An exemplary embodiment of the present invention includes at least one non-transitory computer-readable medium storing computer-readable instructions for generating a view of an augmented reality environment that, when executed by one or more computing devices, cause at least one of the one or more computing devices to: generate an augmented reality (AR) environment based at least in part on one or more audiovisual feeds of a set captured by one or more physical cameras and one or more three-dimensional graphics models of a virtual environment; track a current viewpoint location within the AR environment, the current viewpoint location corresponding to one or more of: a physical location of a physical camera in the one or more physical cameras or a virtual location of a virtual camera in the virtual environment; and generate a view of the AR environment based at least in part on the current viewpoint location.

Another exemplary embodiment of the present invention includes a method executed by one or more computing devices configured for generating an output view of an augmented reality environment during a transition between virtual and physical cameras, the method comprising: providing a physical film set; providing one or more audiovisual feeds of the physical film set captured by one or more physical cameras; providing the one or more computing devices configured to generate the augmented reality environment; generating, by the one or more computing devices, one or more three-dimensional graphics model of a virtual film set, where the virtual film set includes at least a location representation of the physical film set and the one or more physical cameras; generating, by the one or more computing devices, one or more virtual feeds of the virtual film set captured by one or more virtual cameras; establishing, for the one or more virtual cameras, at least one virtual camera pathway in the one or more three-dimensional graphic model that passes at or near at least one of the location representations of the one or more physical cameras; generating, by the one or more computing devices, a transition point where the at least one virtual camera pathway passes at or near the location representation of the at least one of the one or more physical cameras; establishing and transmitting spatial coordinates and orientation vectors of the one or more physical cameras to the one or more computing devices; establishing and transmitting spatial coordinates and orientation vectors of the one or more virtual cameras along the at least one virtual camera pathway to the one or more computing devices; synchronizing, by the one or more computing devices, the spatial coordinates and orientation vectors of the one or more virtual cameras to the one or more physical cameras at the transition point; generating, by the one or more computing devices, a current viewpoint location within the augmented reality environment, where the current viewpoint location corresponds to a physical location of the one or more physical cameras and/or a virtual location of the one or more virtual cameras along the at least one virtual camera pathway; sending a transition instruction, by a command, to the one or more computing devices to transition the current viewpoint location from the one or more physical cameras to the one or more virtual cameras at the transition point, or, from the one or more virtual cameras to the one or more physical cameras at the transition point; generating and transmitting, by the one or more computing devices, the output view of the augmented reality environment based on the current viewpoint location including the transition point.

The physical film set may comprise one or more light emitting diode (LED) panels and wherein the one more LED panels are configured to output a portion of the virtual feed based at least in part on the current viewpoint location of the one or more virtual cameras when the current viewpoint location is not at the transition point.

The physical film set may include at least one physical object and wherein the one or more three-dimensional graphics model of a virtual film set includes a corresponding virtual object that matches the physical object.

The command sending the transition instruction may be by a human user or may be by the one or more computing devices.

The one or more computing devices may include at least one processing unit and a memory, where the at least one processing unit is configured to execute computer-executable instructions and where the memory is volatile memory and/or non-volatile memory.

In summary, an apparatus, method, and computer-readable medium for generating a view of an augmented reality environment is disclosed. It includes: generating an augmented reality environment based at least in part on one or more audiovisual feeds of a set captured by one or more physical cameras and one or more three-dimensional graphics models of a virtual environment; tracking a current viewpoint location within the AR environment, where the current viewpoint location corresponding to one or more of a physical location of a physical camera in the one or more physical cameras or a virtual location of a virtual camera in the virtual environment; and generating a view of the AR environment based at least in part on the current viewpoint location.

### BRIEF DESCRIPTION OF THE DRAWINGS

FIG. 1 illustrates a flowchart for generating a view of an augmented reality environment according to an exemplary embodiment.

FIG. 2 illustrates a diagram of AR environment generation according to an exemplary embodiment.

FIG. 3 illustrates a diagram of current viewpoint location tracking according to an exemplary embodiment.

FIG. 4 illustrates a system flow diagram for generating the view of the AR environment according to an exemplary embodiment.

FIG. 5 illustrates an example of a set and AR environment generation according to an exemplary embodiment.

FIG. 6 illustrates an example of a three-dimensional model used for generating the AR environment according to an exemplary embodiment.

FIG. 7A illustrates a view of the AR environment according to an exemplary embodiment

FIG. 7B illustrates a different view of the AR environment according to an exemplary embodiment.

FIG. 7C illustrates a different view of the AR environment according to an exemplary embodiment.

FIG. 7D illustrates a different view of the AR environment according to an exemplary embodiment.

FIG. 7E illustrates a different view of the AR environment according to an exemplary embodiment.

FIG. 7F illustrates a different view of the AR environment according to an exemplary embodiment.

FIG. 7G illustrates a different view of the AR environment according to an exemplary embodiment.

FIG. 7H illustrates a different view of the AR environment according to an exemplary embodiment.

FIG. 7I illustrates a different view of the AR environment according to an exemplary embodiment.

FIG. 7J illustrates a different view of the AR environment according to an exemplary embodiment.

FIG. 7K illustrates a different view of the AR environment according to an exemplary embodiment.

FIG. 7L illustrates a different view of the AR environment according to an exemplary embodiment.

FIG. 7M illustrates a different view of the AR environment according to an exemplary embodiment.

FIG. 7N illustrates a different view of the AR environment according to an exemplary embodiment.

FIG. 7O illustrates a different view of the AR environment according to an exemplary embodiment.

FIG. 7P illustrates a different view of the AR environment according to an exemplary embodiment.

FIG. 7Q illustrates a different view of the AR environment according to an exemplary embodiment.

FIG. 7R illustrates a different view of the AR environment according to an exemplary embodiment.

FIG. 7S illustrates a different view of the AR environment according to an exemplary embodiment.

FIG. 7T illustrates a different view of the AR environment according to an exemplary embodiment.

FIG. 8A illustrates the physical and non-physical portions of view of an AR environment according to an exemplary embodiment.

FIG. 8B also illustrates the physical and non-physical portions of view of an AR environment according to an exemplary embodiment.

FIG. 9 illustrates a view of the AR environment that is generated based solely on the virtual environment according to an exemplary embodiment.

FIG. 10 illustrates a flowchart for transitioning a current viewpoint location within an AR scene according to an exemplary embodiment.

FIG. 11A illustrates an example of virtual camera pathways in the virtual environment according to an exemplary embodiment.

FIG. 11B illustrates another example of virtual camera pathways in the virtual environment according to an exemplary embodiment.

FIG. 11C illustrates another example of virtual camera pathways in the virtual environment according to an exemplary embodiment.

FIG. 11D illustrates another example of virtual camera pathways in the virtual environment according to an exemplary embodiment.

FIG. 12 illustrates a flowchart for transitioning between a virtual camera and a physical camera according to an exemplary embodiment.

FIG. 13 illustrates a flowchart for transitioning from a physical camera to a virtual camera according to an exemplary embodiment.

FIG. 14A illustrates a control interface of the present system according to an exemplary embodiment.

FIG. 14B illustrates a different control interface of the present system according to an exemplary embodiment.

FIG. 14C illustrates a different control interface of the present system according to an exemplary embodiment.

FIG. 15 illustrates a workflow diagram of the rail system and transitions between physical and virtual cameras.

FIG. 16 illustrates an example of a specialized computing environment used to perform the above-described methods and implement the above-described systems.

### DETAILED DESCRIPTION OF EMBODIMENT OF THE INVENTION

While methods, systems, and computer-readable media are described herein by way of examples and embodiments, those skilled in the art recognize that methods, systems, and computer-readable media for generating a view of an augmented reality environment are not limited to the embodiments or drawings described. It is understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” and “includes” mean including, but not limited to.

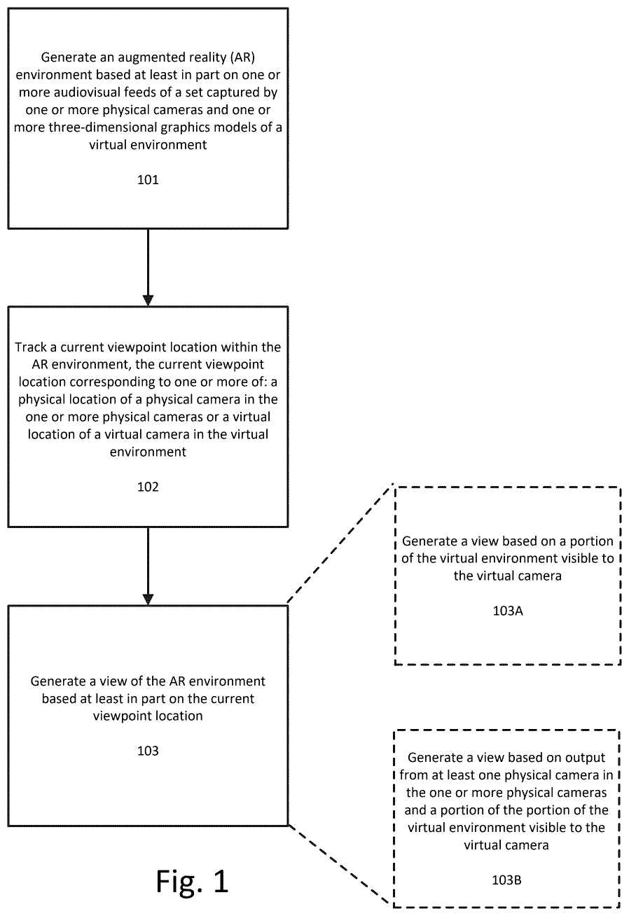

FIG. 1 illustrates a flowchart for generating a view of an augmented reality environment according to an exemplary embodiment. The steps in the flowchart can be performed by one or more computing devices of an augmented reality and/or extended reality view generation software, including, for example, television or sports production software used to produce streams of mixed reality media.

At step 101 an augmented reality (AR) environment is generated based at least in part on one or more audiovisual feeds of a set captured by one or more physical cameras and one or more three-dimensional graphics models of a virtual environment. The AR environment includes both the physical objects in the set captured by the physical cameras, as well as aspects of the three-dimensional graphics models of the virtual environment.

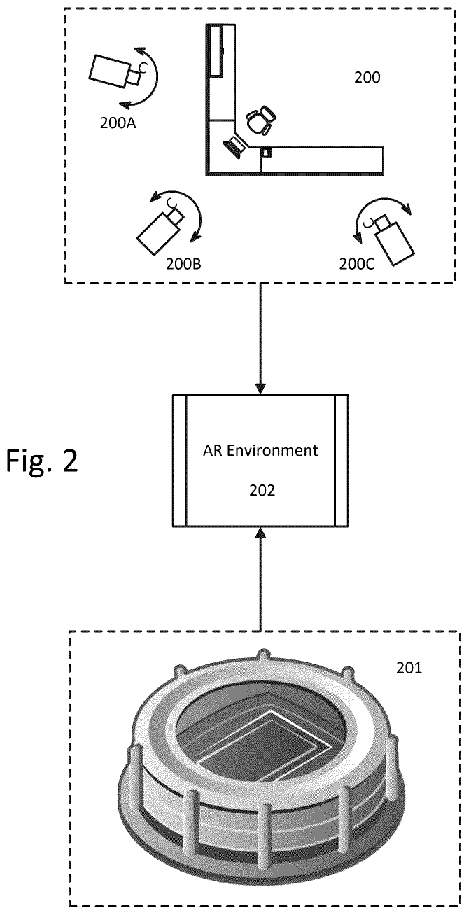

FIG. 2 illustrates a diagram of AR environment generation according to an exemplary embodiment. The audiovisual output of a set 200 that is captured by one or more physical cameras, such as cameras 200A, 200B, and 200C, is provided as one of the inputs to the software which generates the AR environment 202. The sets can include physical objects, such as desks, chairs, podiums, personnel/hosts/talent, and other physical objects. As discussed further below, the sets can also include displays, such as light emitting diode (LED) displays that output content, including views from the virtual environment.

Additional, one or more three-dimensional graphics models, such as model 201, are also provided as input to generate the AR environment 202. The example model in FIG. 2 is of a stadium, but it is understood that the one or more three-dimensional models can model any setting, such as different buildings, landscapes, interiors, objects, fictional environments, etc. The three-dimensional models can include light sources and lighting effects, as well as other computer graphics techniques and features. In the case of light sources, the AR/XR engine can alter the rendering of physical objects on the physical set based on these light sources. The three-dimensional models can include animations that model change in objects as well. The three-dimensional models can be created with any type of graphics engine or renderer, such as the Unreal Engine® or other graphics libraries/engines. The three-dimensional models can also be CAD models or models created by any type of modeling software.

Returning to FIG. 1, at step 102 a current viewpoint location within the AR environment is tracked, the current viewpoint location corresponding to one or more of: a physical location of a physical camera in the one or more physical cameras or a virtual location of a virtual camera in the virtual environment. The current viewpoint location is the universal location within the AR environment and is used both by physical camera systems and by virtual cameras within the virtual environment. For mixed reality output, such as AR or extended reality (XR), this allows any view of the AR environment to include both the relevant physical objects, as well as the virtual objects from the virtual environment that should be included in the view. In some cases, only the virtual environment is shown, and in these cases, the current viewpoint location can correspond to a location of a virtual camera within the virtual environment.

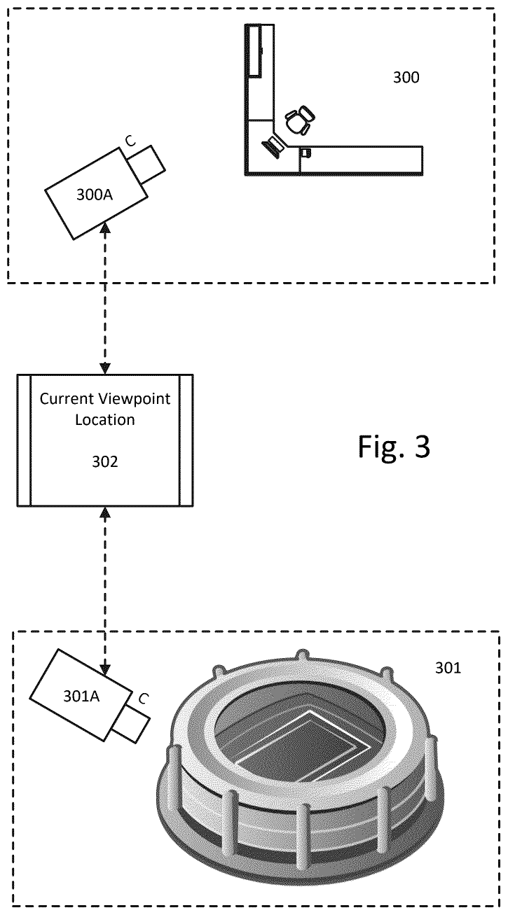

FIG. 3 illustrates a diagram of current viewpoint location tracking according to an exemplary embodiment. As shown in FIG. 3, the location of a physical camera 300A relative to a set 300 and/or the location of a virtual camera 301A within a virtual environment can be used to determine current viewpoint location. Since both physical and virtual cameras track the current location, this allows for seamless transitions between virtual and AR or physical environments, as will be discussed further below. It should be understood that location, both for the physical cameras and the virtual cameras, includes spatial coordinates (X,Y,Z coordinates), as well as orientation vectors (e.g., pan, tilt, direction) and zoom settings.

Returning to FIG. 1, at step 103 a view of the AR environment is generated based at least in part on the current viewpoint location. This view can capture both the physical objects in the physical set, as well as the virtual objects in the virtual environment based on the current viewpoint location and the AR environment. Alternatively, in some cases, the view of the AR environment can correspond to only the virtual environment. This is because some portions of the virtual environment will sometimes not have corresponding physical counterparts on the set. In these cases, the view of the AR environment is a view of the virtual environment, since no portion of the set is included in the view.

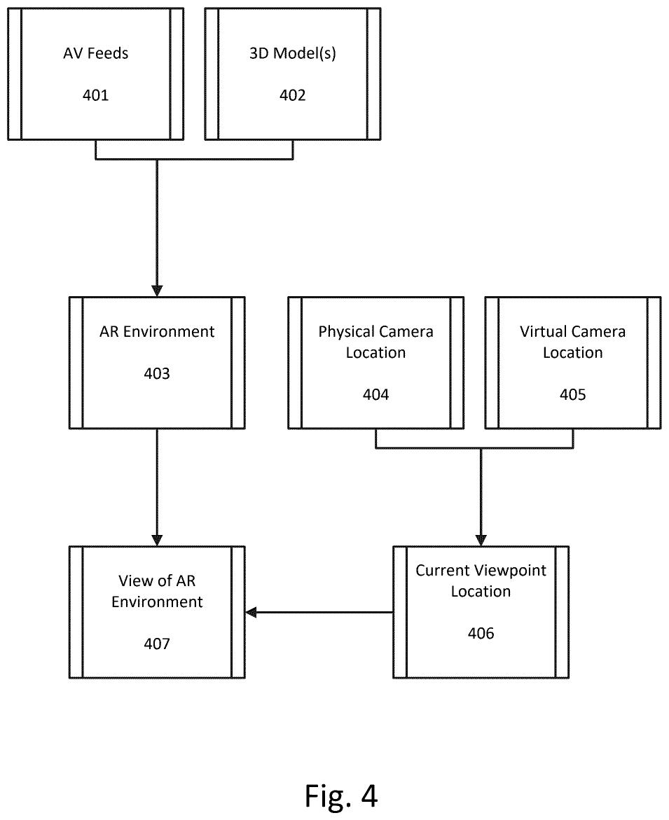

FIG. 4 illustrates a system flow diagram for generating the view of the AR environment according to an exemplary embodiment. As shown in FIG. 4, AV feeds 401 from physical cameras and 3D models 402 are used to generate the AR environment 403. Additionally, physical camera location 404 and/or virtual camera location 405 correspond to the current viewpoint location 406 (which is the universal location in the AR environment). The current viewpoint location 406 is then used with the AR environment 403 to generate the view (i.e., output, display) of the AR environment 407.

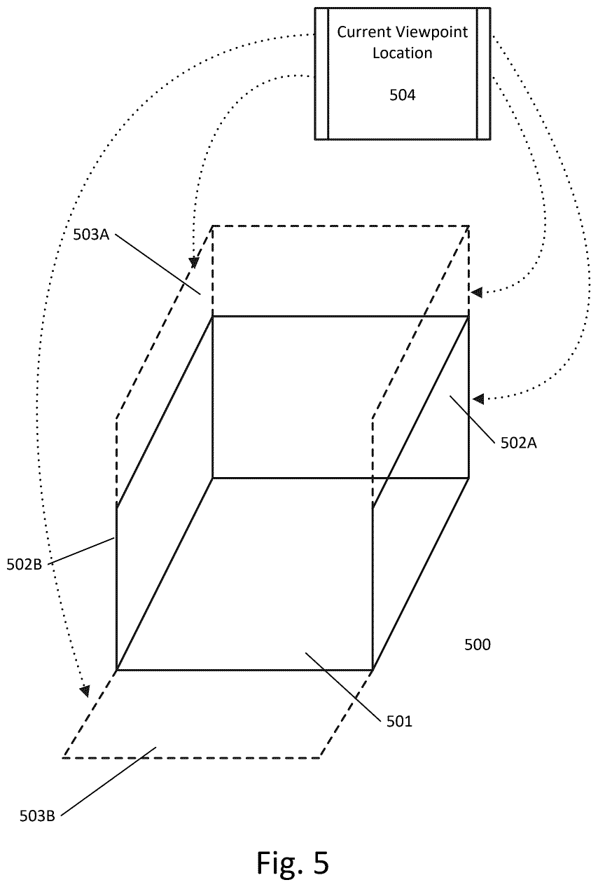

FIG. 5 illustrates an example of a set and AR environment generation according to an exemplary embodiment. The set 500 includes physical components/objects, shown in solid lines. The physical components/objects can be, for example a floor 501 or walls 502A and 502B. The physical objects can be displays, such as LED panels or other types of displays. For example, walls 502A and 502B can be LED panels. The LED panels can be configured to output a portion of the virtual environment based at least in part on the current viewpoint location 504. FIG. 5 also illustrates, in dashed lines, portions of the AR or XR output that are not part of the physical set. This includes extended areas above the walls, such as area 503A, or extended areas in front of the floor, such as 503B. These extended areas can extend far enough upward and/or outward that no portion of the physical set is seen in these directions. These AR/XR areas can be rendered with output from the virtual environment based at least in part on the current viewpoint location and the virtual model(s), so that the subjects in the set appear to be completely immersed in the virtual environment, regardless of the angle at which they are viewed. Of course, the floor 501 can also be rendered as an AR/XR area so that the true floor of the set is not visible in the view of the AR environment. In this way, the AR environment allows for the viewpoint to move around in 360 degrees while maintaining the appropriate imagery and rendering of the virtual environment and the physical objects on the set.

It has been a struggle in the prior art to seamlessly integrate a LED display with the augmented reality environment. Importantly, in this teaching, the LED display is configured to output a portion of the virtual feed based at least in part on the current viewpoint location of the one or more virtual cameras when the current viewpoint location is not at the transition point. Because the LED display and the augmented reality are essentially displaying the same visual information the seamless integration is now drastically improved. Thus, as the virtual camera moves along the rail, the LED display can be constantly changing. This may look odd to a viewer of the physical camera, as the physical camera might notice the LED display changing in an undesired way, but to the virtual camera along the rail it will indeed appear correct. Once the transition point is reached, then the LED display will be viewed as correct to both the virtual camera and the physical camera. This can be achieved best when the LED display is positioned at the end of the physical set which then transitions into the virtual set.

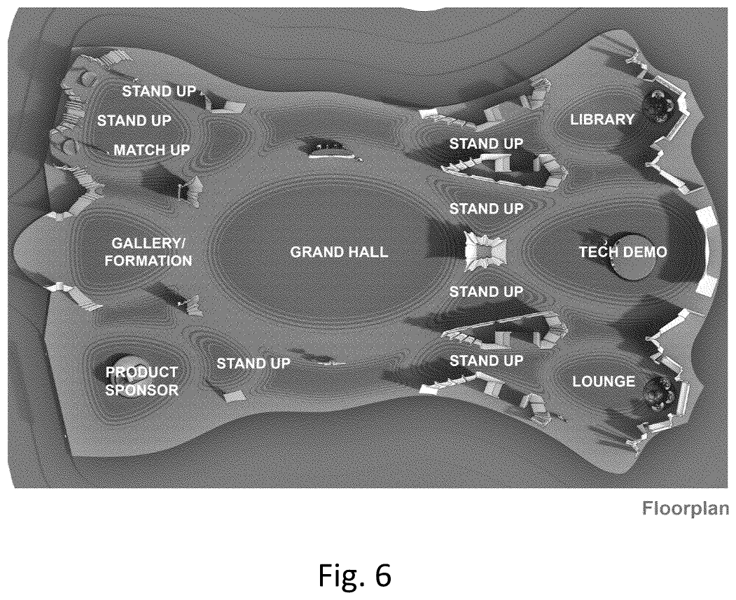

FIG. 6 illustrates an example of a three-dimensional model used for generating the AR environment according to an exemplary embodiment. As shown in FIG. 6, the 3D model can include different areas and sub-models, such as product sponsor model that can include 3D models of products from sponsors. The 3D model can also include renderings or structures corresponding to the environments outside a particular area.

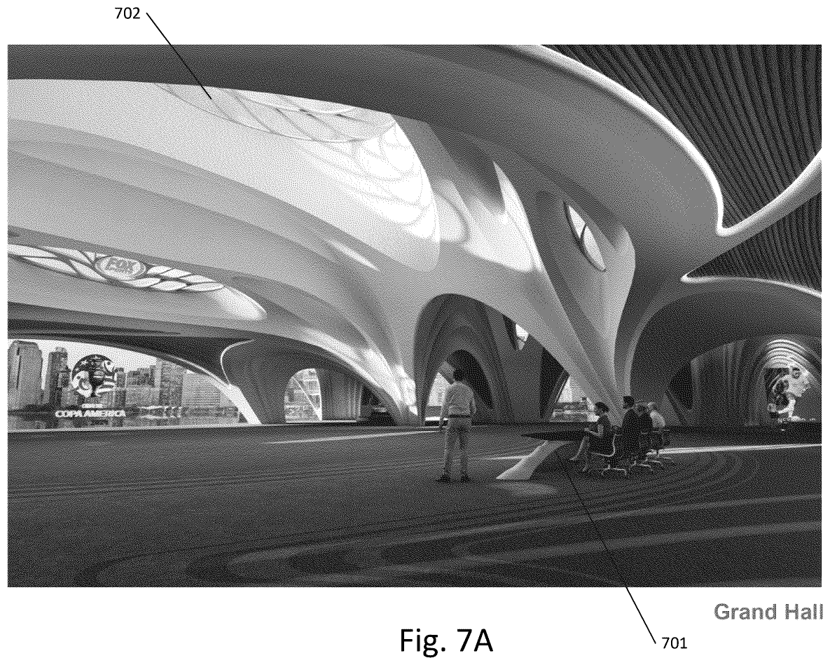

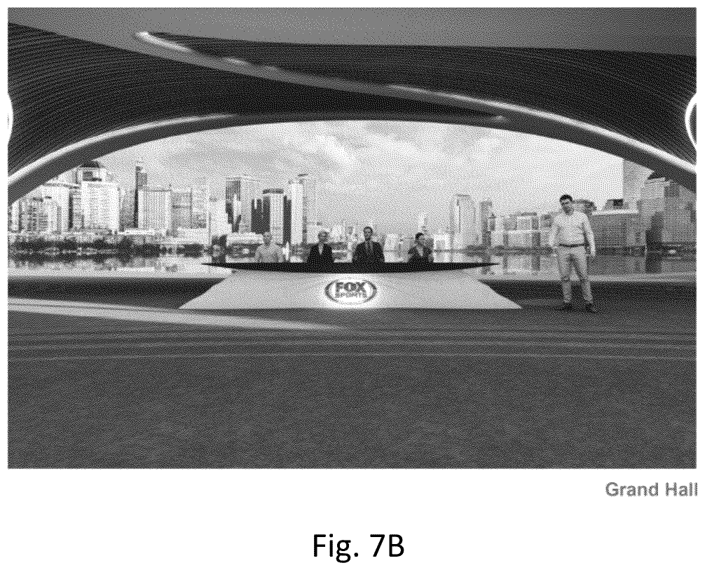

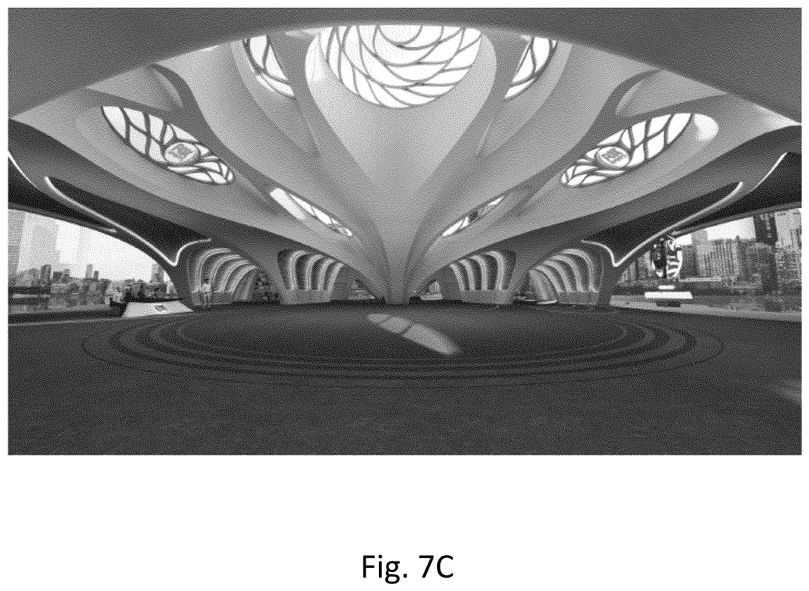

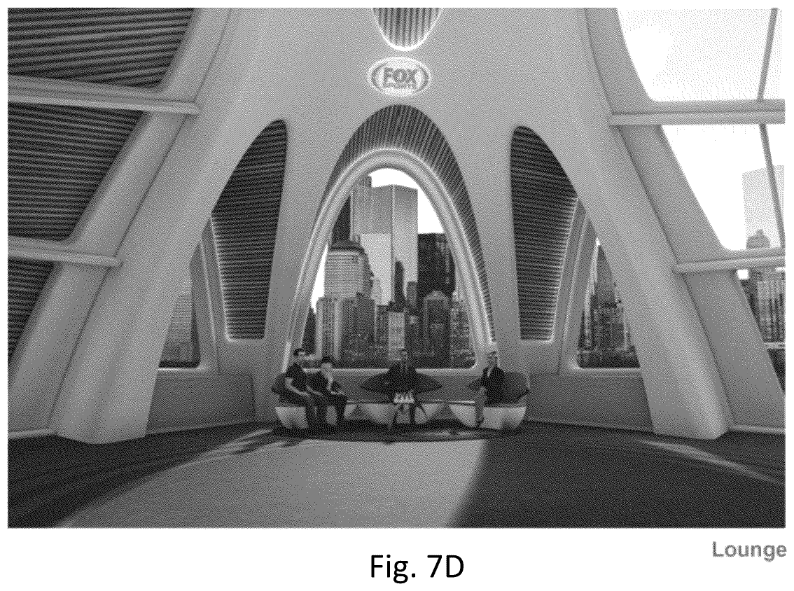

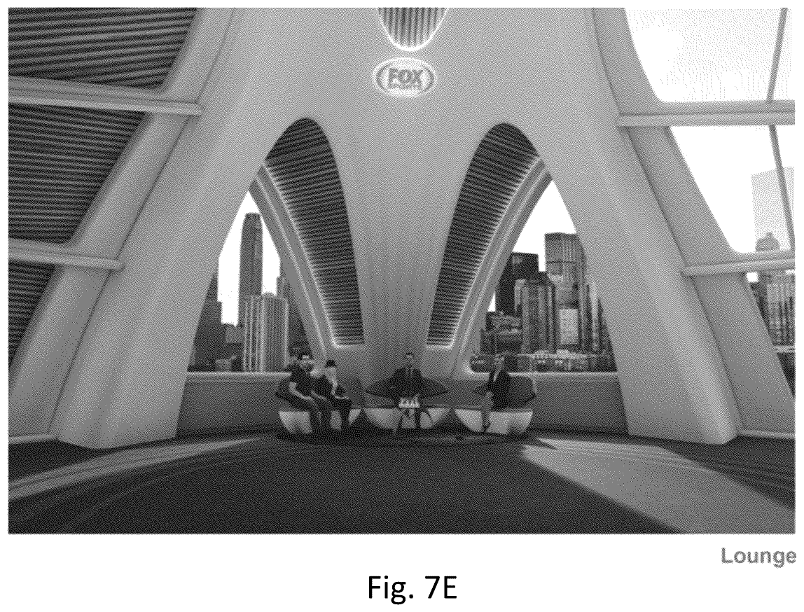

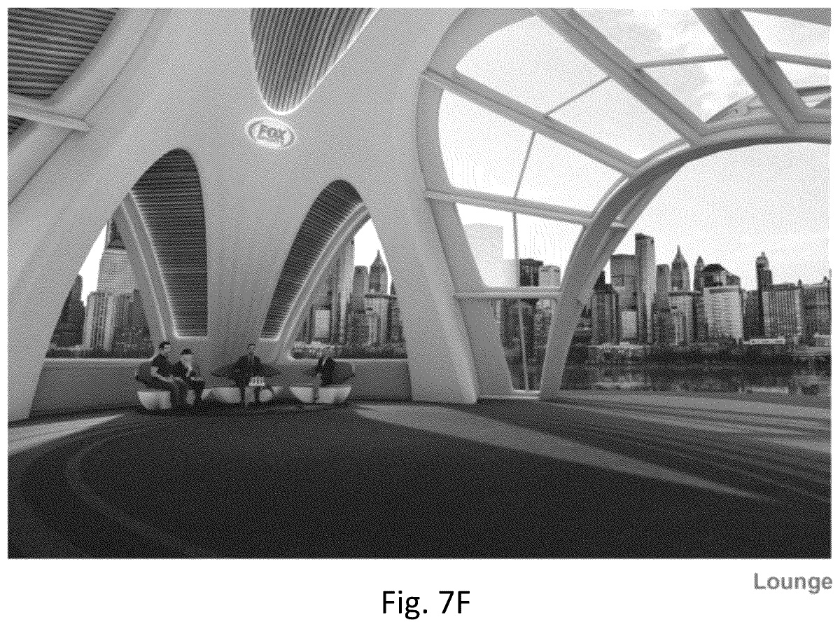

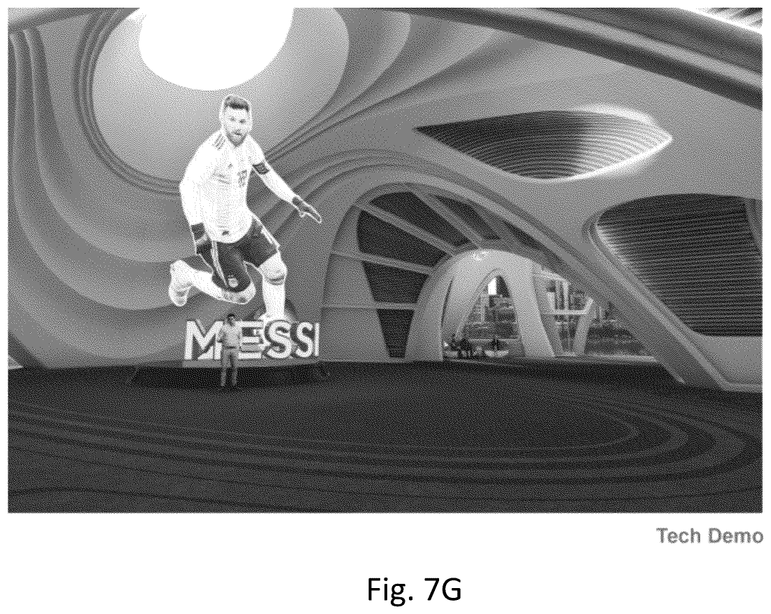

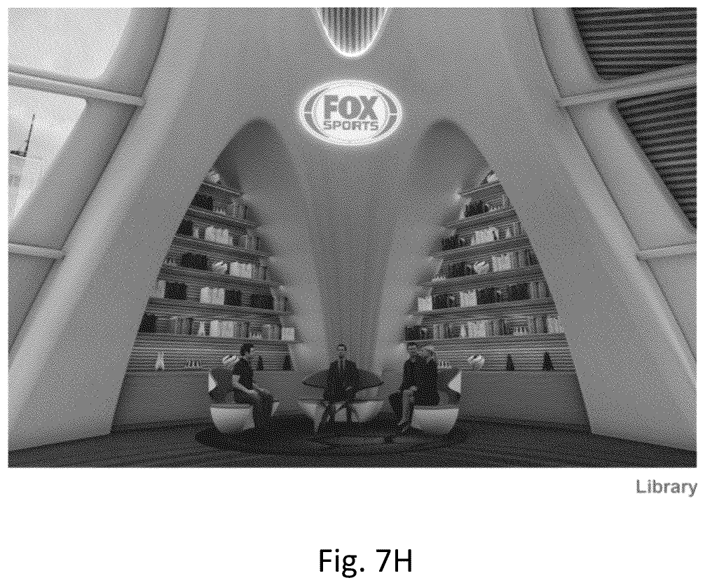

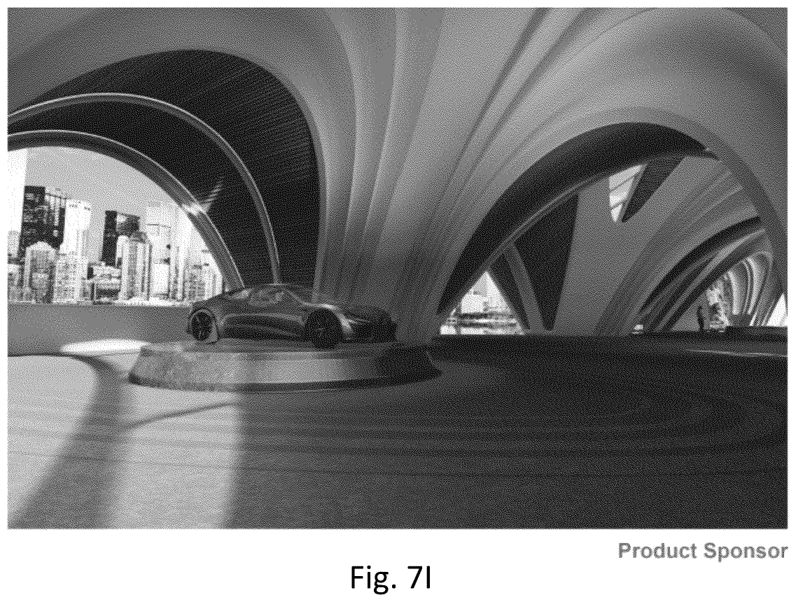

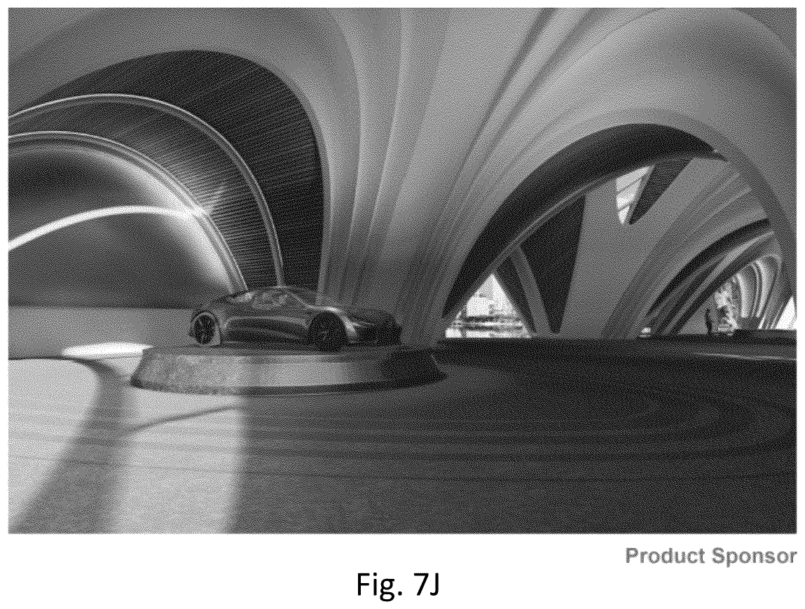

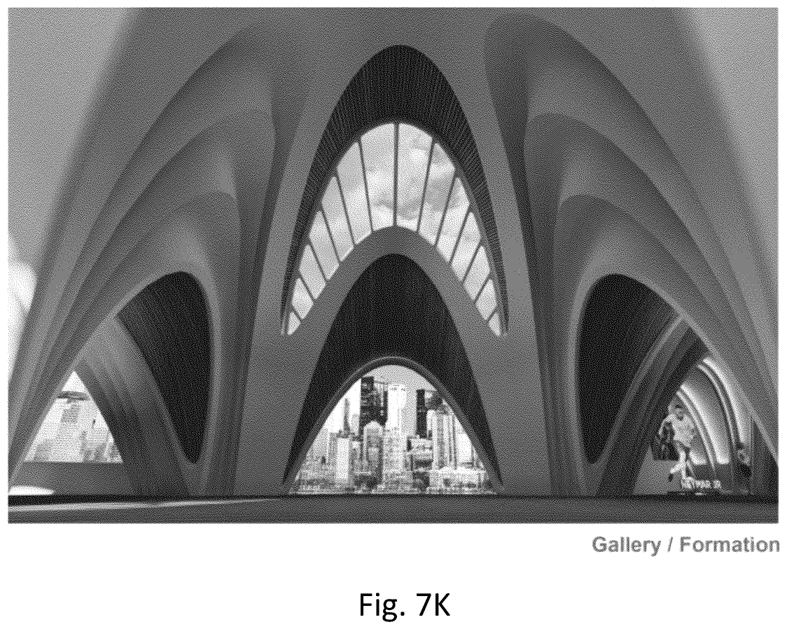

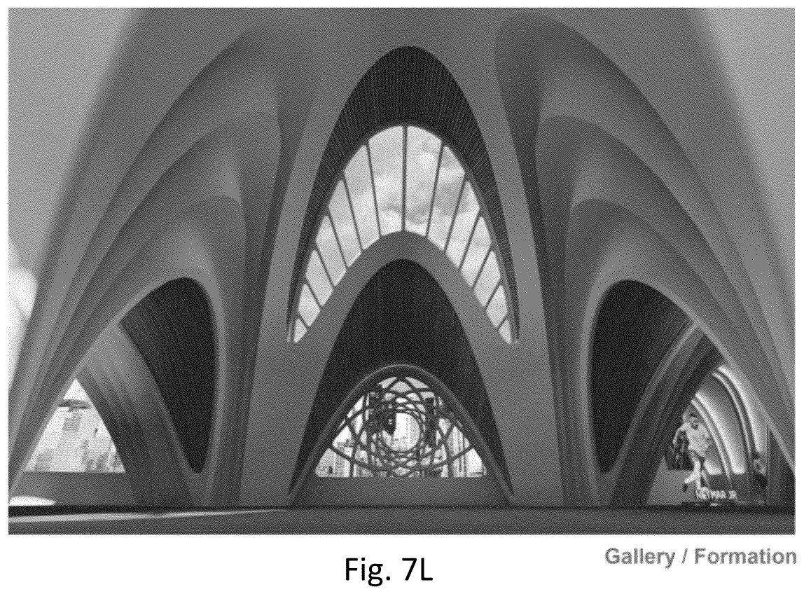

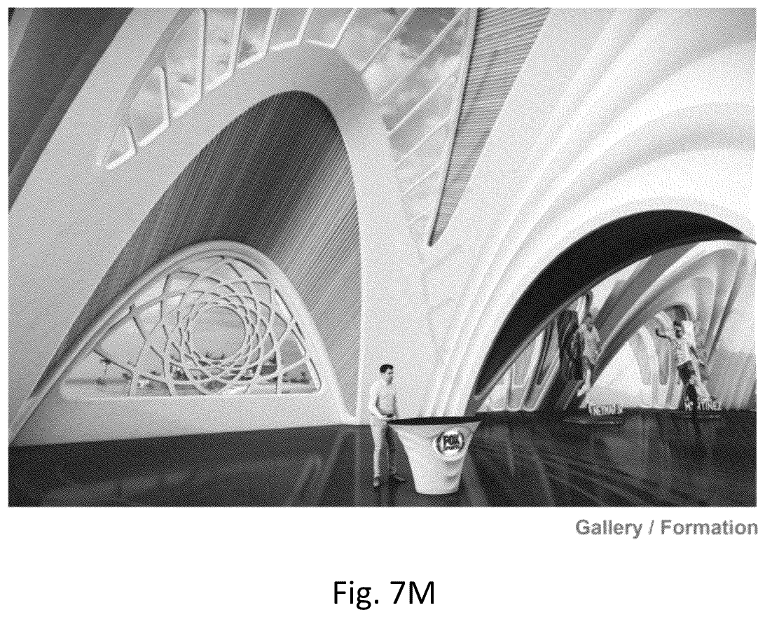

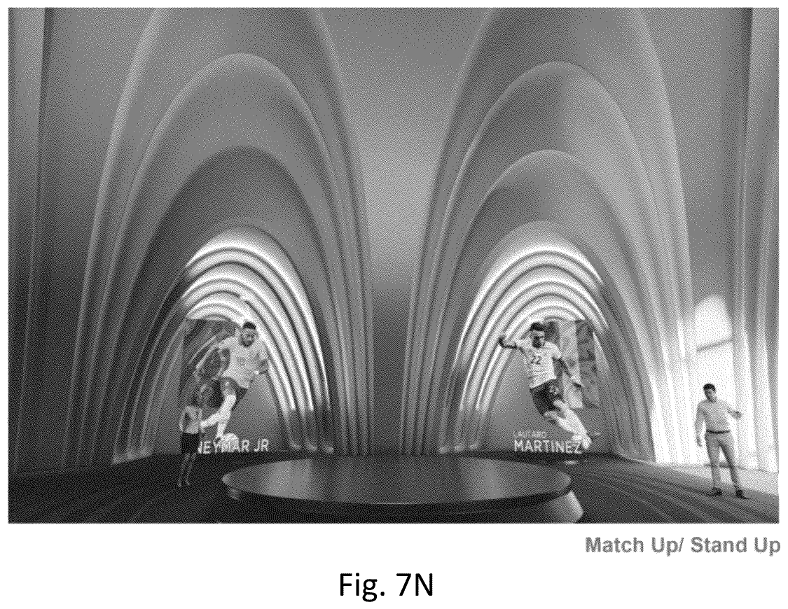

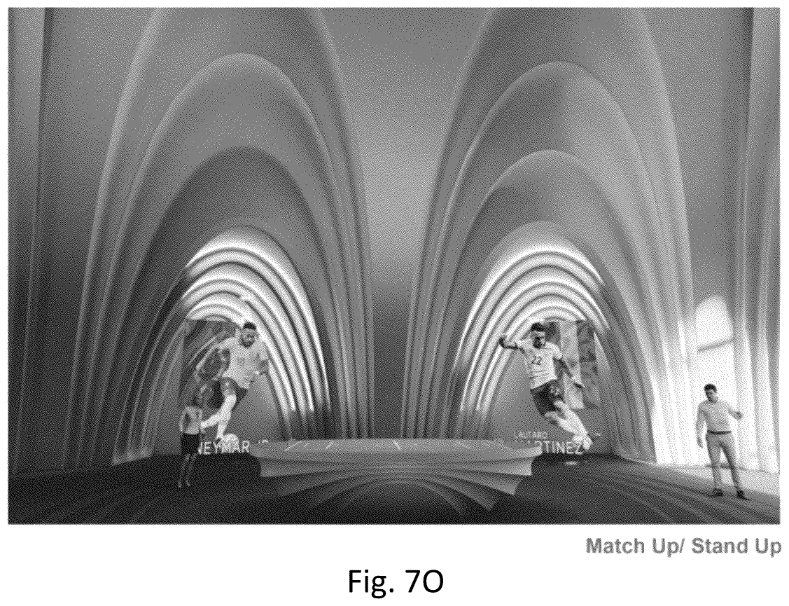

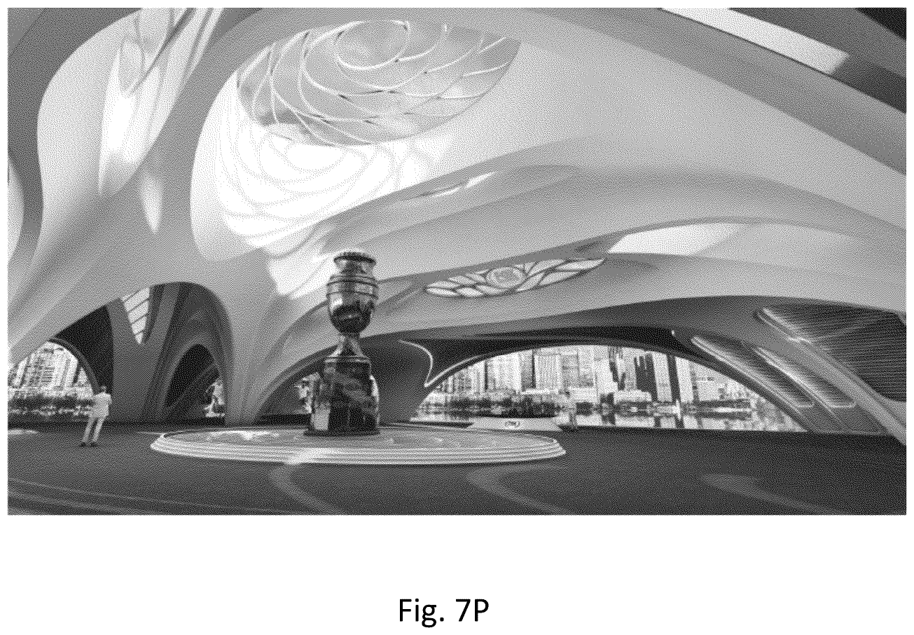

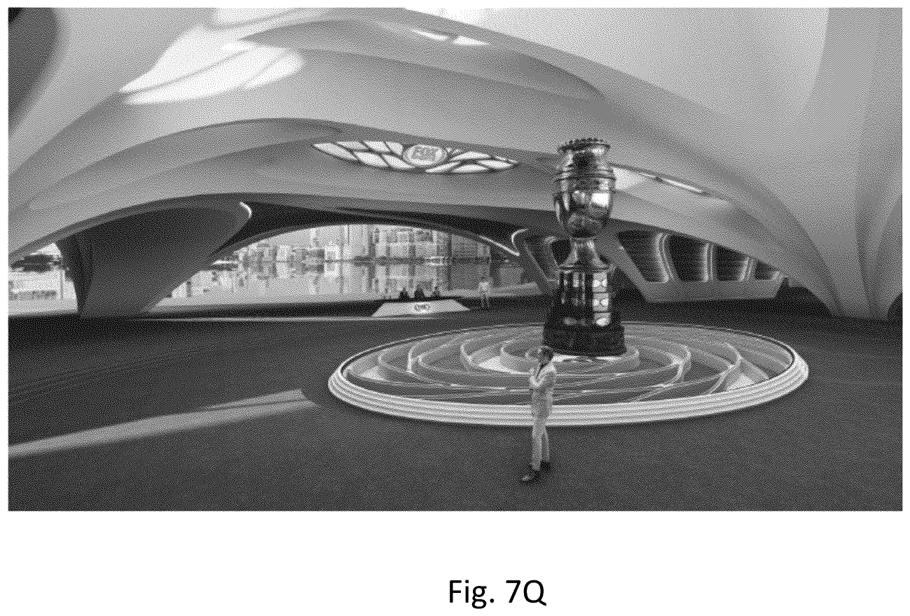

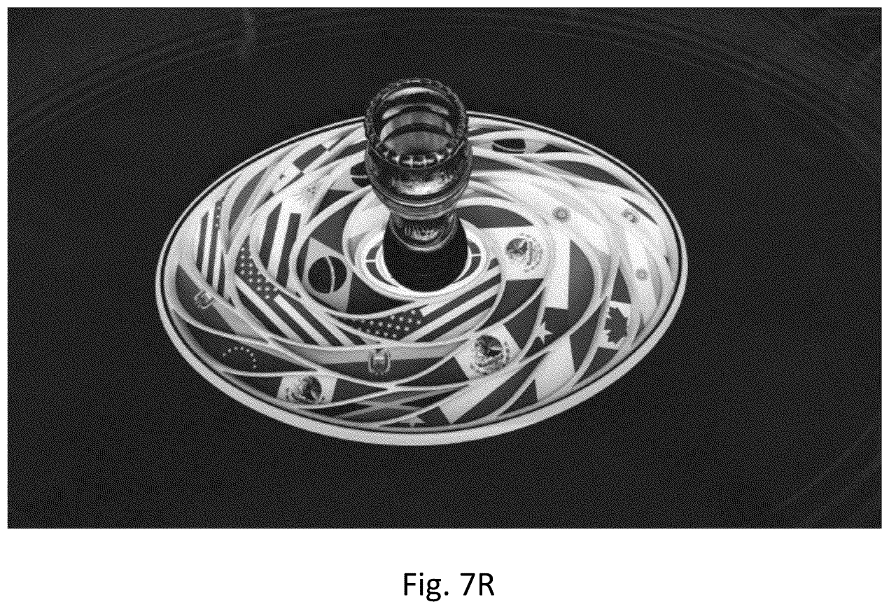

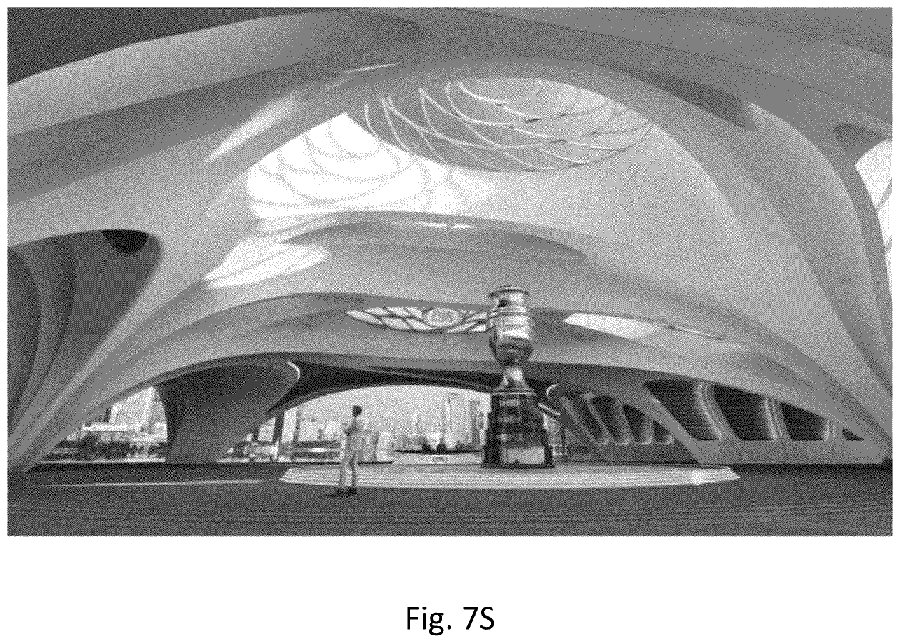

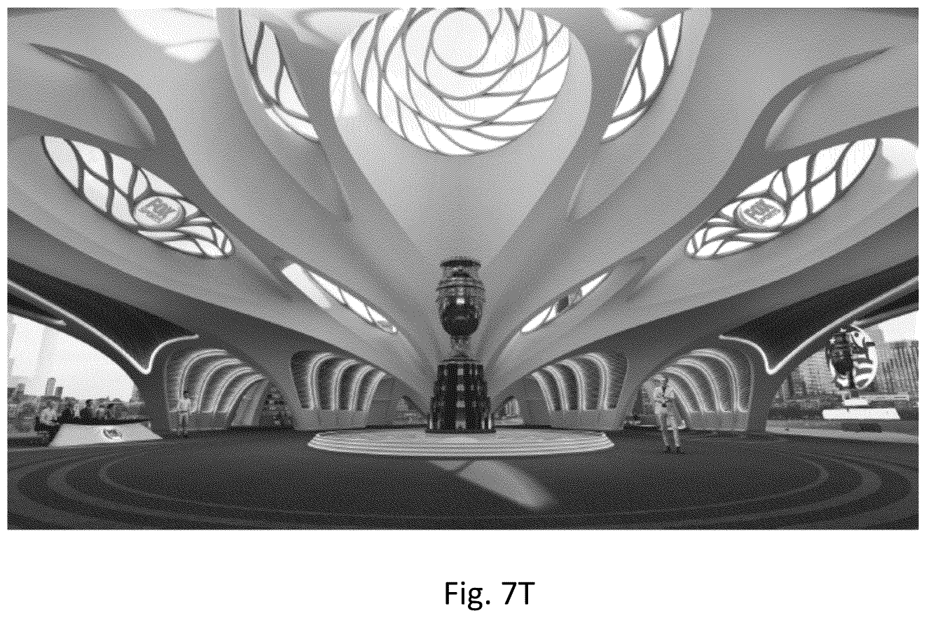

FIGS. 7A-7T illustrates different views of the AR environment according to an exemplary embodiment. Many of these views show both the virtual environment as well as the physical sets and physical objects (including people) within the physical sets. For example, FIG. 7A identifies physical objects 701, as well as the virtual environment 702. The virtual environment portions of the AR environment can be modified dynamically, such as shown in FIGS. 7D-7E. For example, the virtual environment can model changes in time of day, season, etc.

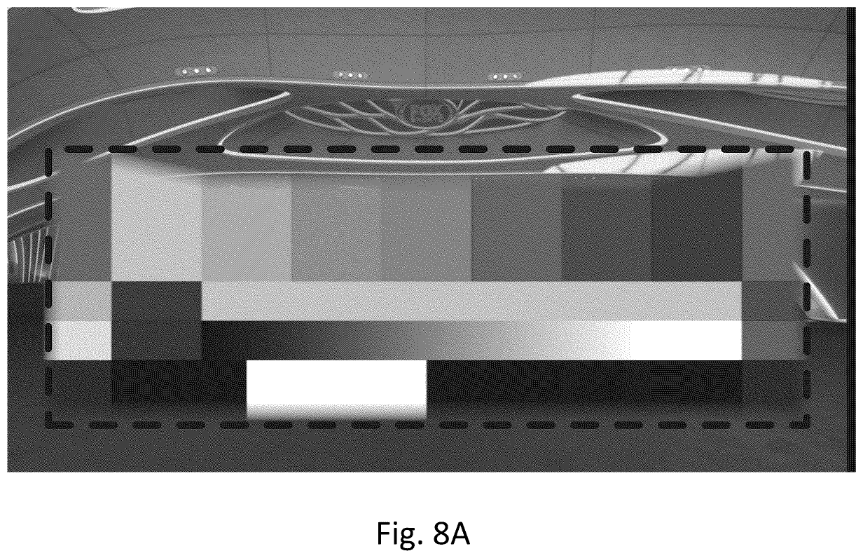

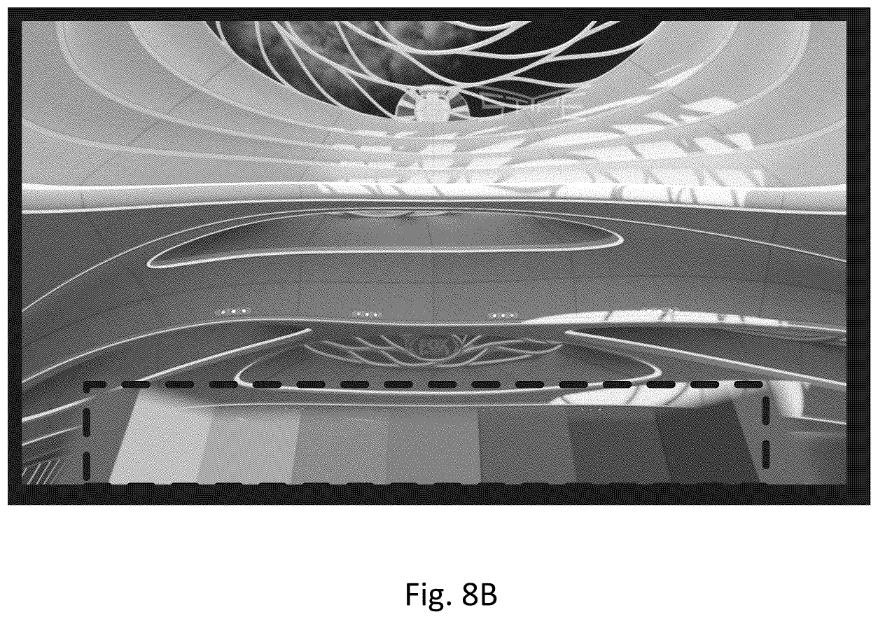

FIGS. 8A and 8B illustrate the physical and non-physical portions of view of an AR environment according to an exemplary embodiment. The dashed rectangles in these figures illustrate the portion of the views that are provided by the feed from the physical cameras, and the areas outside the dashed rectangles indicate portions of the view that are generated from the virtual environment.

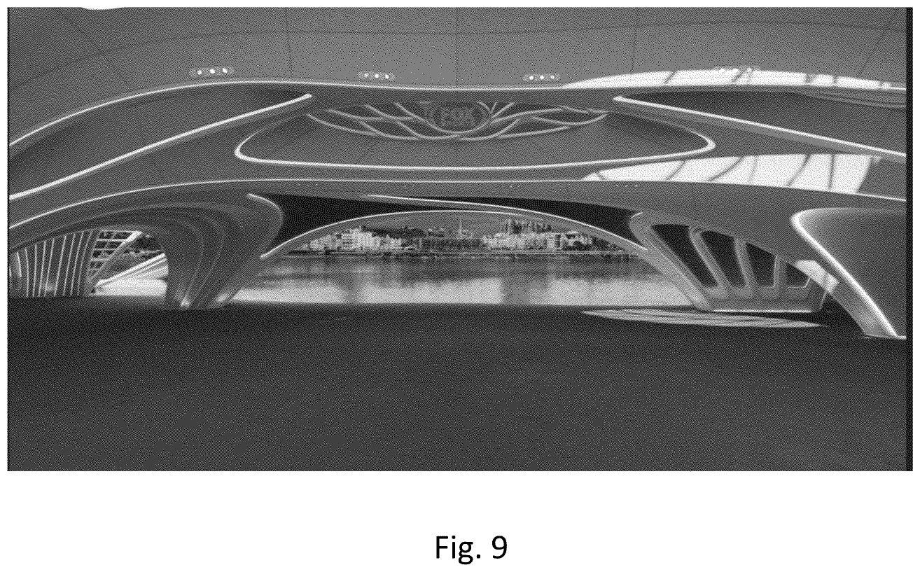

FIG. 9 illustrates a view of the AR environment that is generated based solely on the virtual environment according to an exemplary embodiment. As shown in FIG. 9, the view does not include any physical objects from the physical set and can correspond to a current viewpoint location that is outside the bounds of the physical set.

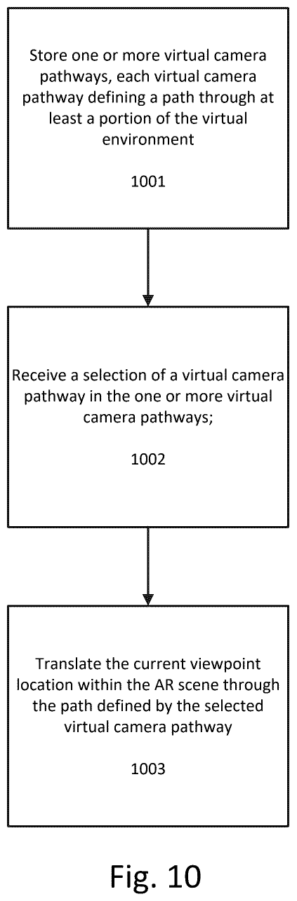

The Applicant has discovered methods and systems for transitioning between virtual environments and physical/mixed reality environments, such as AR or XR. These methods and systems are described with respect to FIGS. 10-14.

FIG. 10 illustrates a flowchart for transitioning a current viewpoint location within an AR scene according to an exemplary embodiment.

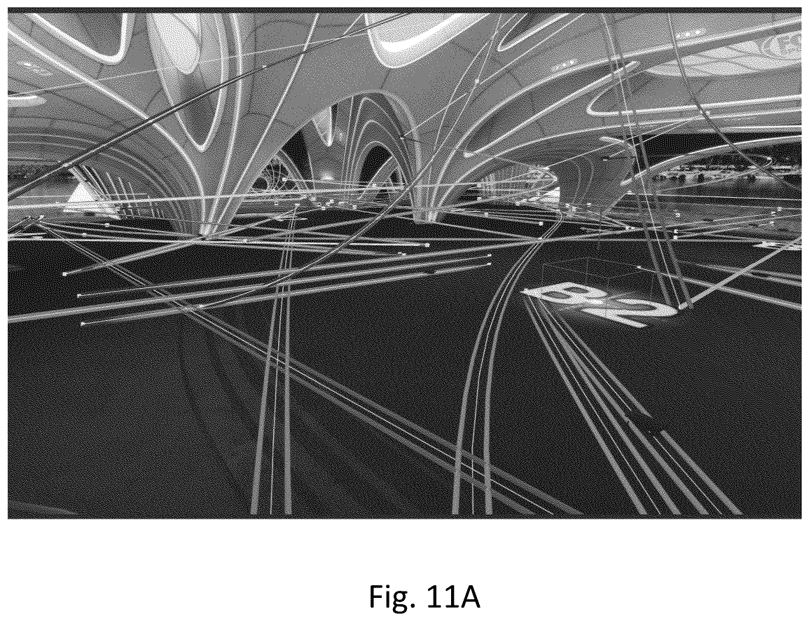

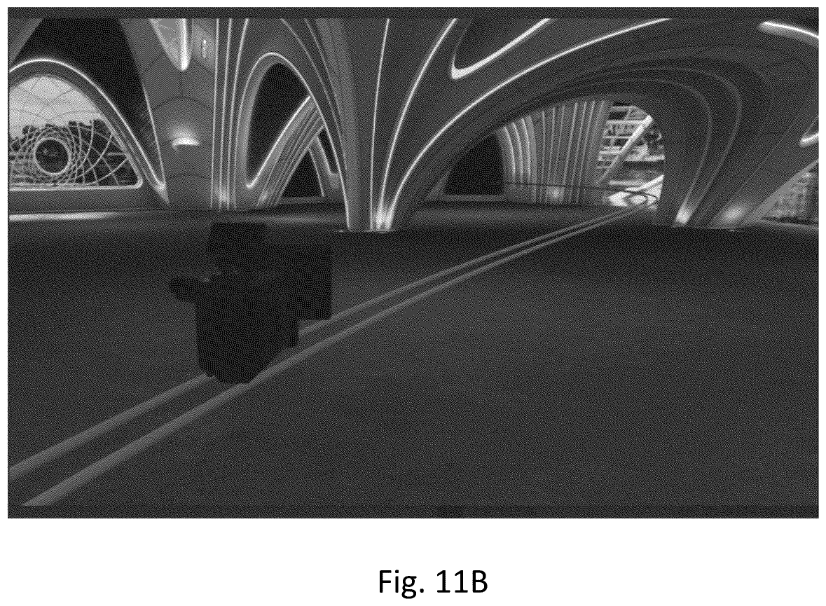

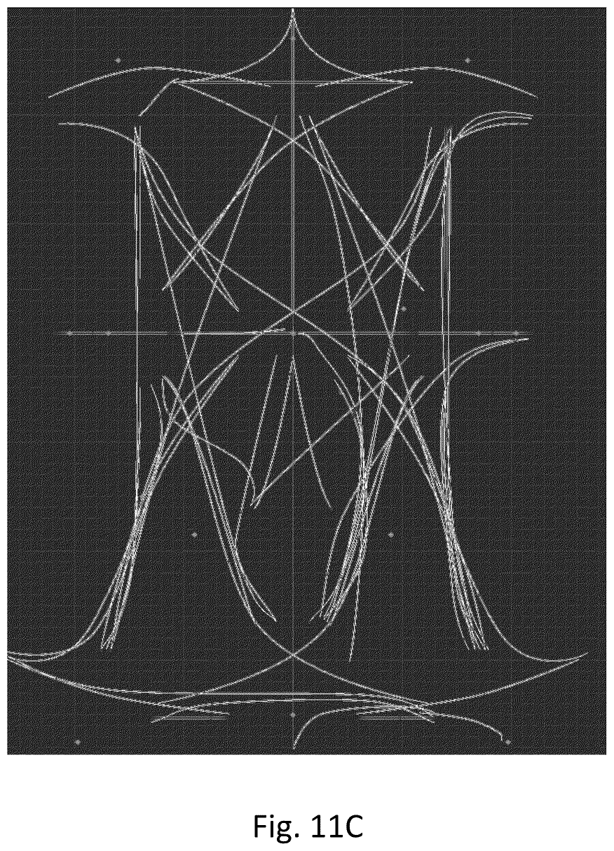

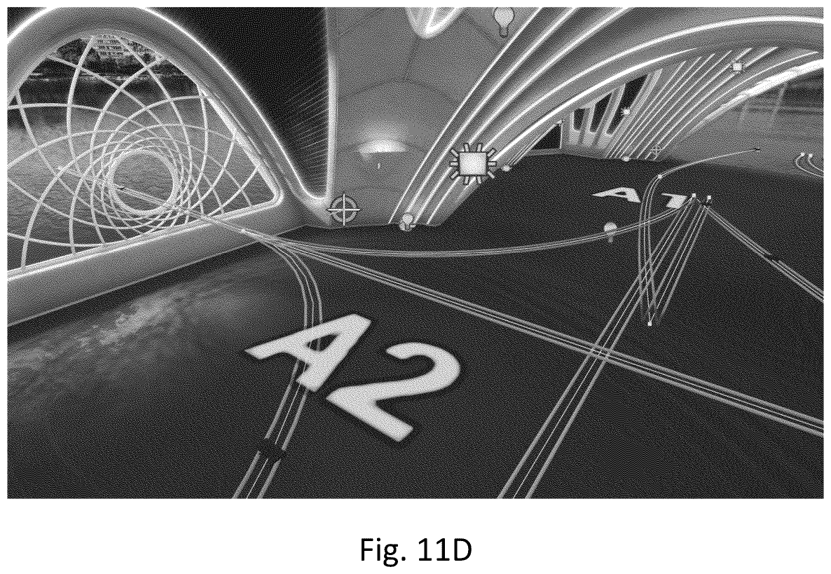

At step 1001 one or more virtual camera pathways are stored, each virtual camera pathway defining a path through at least a portion of the virtual environment. These virtual camera pathways are also referred to herein as “rails.” FIGS. 11A-11D illustrate examples of virtual camera pathways in the virtual environment according to an exemplary embodiment. FIG. 11B illustrates the virtual camera within the virtual environment. When on these pathways or rails, the virtual camera will transition along the path according to parameters configured by the path, including direction, spatial position, orientation, etc. FIG. 11C illustrates an overhead view of the rails within the virtual environment.

Returning to FIG. 10, at step 1002 a selection of a virtual camera pathway in the one or more virtual camera pathways is received. This selection can be received via a software interface and can be received in real-time or can be pre-programmed according to a routine.

At step 1003 the current viewpoint location within the AR scene is transitioned through the path defined by the selected virtual camera pathway. By updating the current viewpoint location and iterating through the different positions on the selected rail, the view of the AR environment is updated. The view of the AR scene is generated based on the virtual location of the virtual camera in the virtual environment when transitioning the current viewpoint location within the AR scene through the path defined by the selected virtual camera pathway. This transition can proceed according to user-configurable parameters governing the speed of transition, the frame rate, or other values. The user can also terminate the transition at any point or limit the transition to a portion of the rail path.

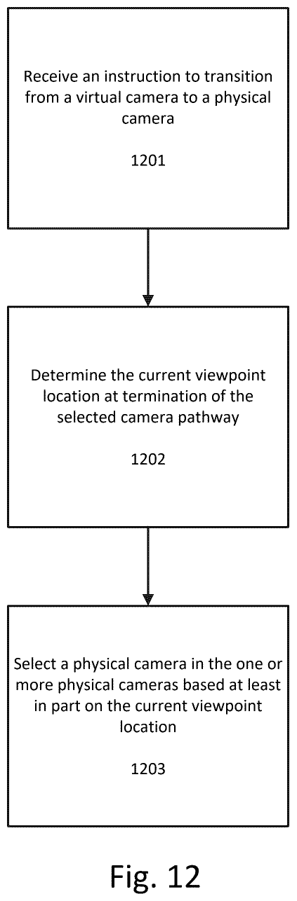

FIG. 12 illustrates a flowchart for transitioning between a virtual camera and a physical camera according to an exemplary embodiment.

At step 1201 an instruction to transition from a virtual camera to a physical camera is received. Again, this instruction can be received in real-time via an interface or can be prescheduled. The instruction can also include parameters identifying a transition area (such as an area of the physical environment), transition time, or a preferred physical camera.

At step 1202 the current viewpoint location at termination of a virtual camera pathway is determined (i.e., transition point). This is the current viewpoint location that will result when the selected rail (or portion of the rail) has been completed.

At step 1203 a physical camera in the one or more physical cameras is selected based at least in part on the current viewpoint location. This can be a physical camera that is best positioned to “take over” (i.e., transition) for the virtual camera within the AR environment. The physical camera can be pre-aligned or moved into the correct position to ensure continuity when the virtual camera is transitioned to the physical camera. This ensures a seamless transition from a purely virtual environment to a mixed/AR environment that incorporates the feed from the physical camera. This can be used, for example, in segments that explore a virtual environment (e.g., via one or more rails) prior to transitioning to a live host on a set (which must be captured via the physical cameras).

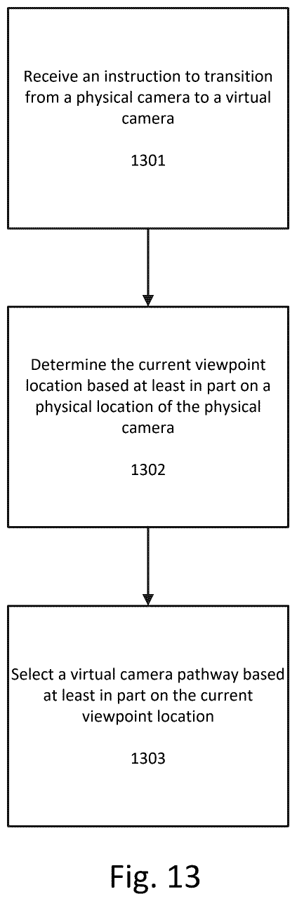

FIG. 13 illustrates a flowchart for transitioning from a physical camera to a virtual camera according to an exemplary embodiment. The process is similar to the process for transitioning from a virtual camera to a physical camera, but in reverse.

At step 1301 an instruction to transition from a physical camera to a virtual camera is received. This instruction can be received via an interface in real time or can be prescheduled.

At step 1302 a current viewpoint location is determined based on a physical location of the physical camera. If the physical camera is on a predetermined path, then a future viewpoint location can be determined based on that path and the termination point.

At step 1303 a virtual camera pathway is selected based at least in part on the current viewpoint location. The virtual camera pathway can be selected, for example, that includes some portion that is proximate to the current viewpoint location. The current viewpoint location can then be transitioned through the selected virtual camera pathway as discussed above.

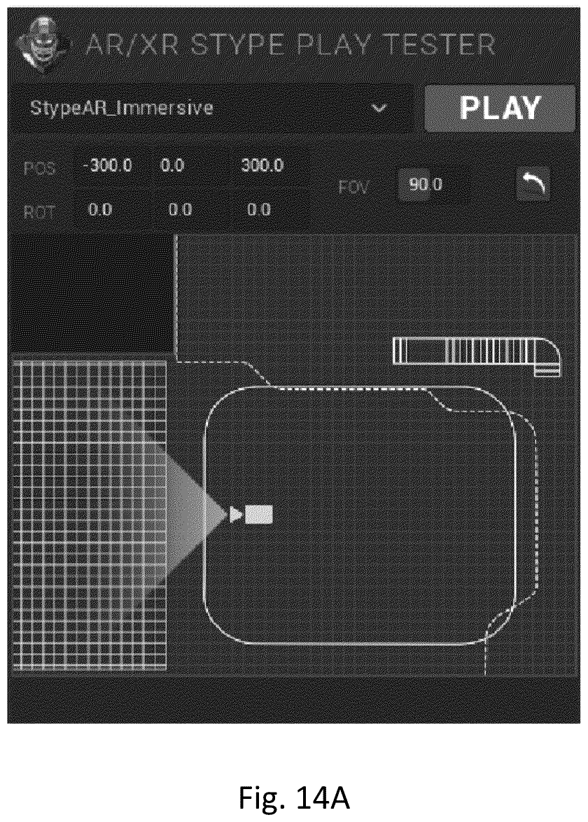

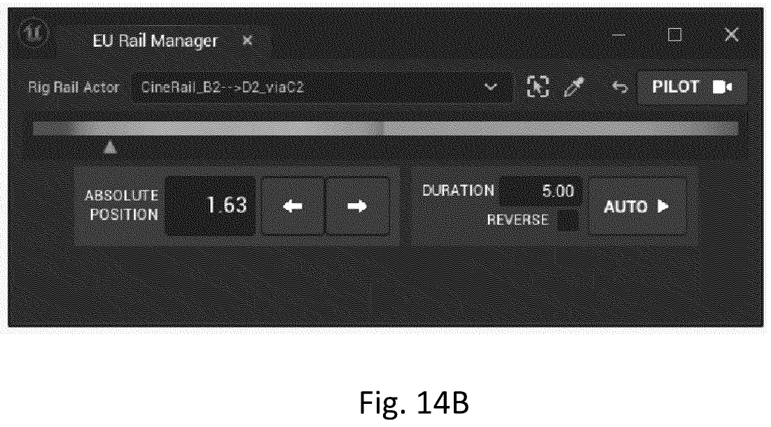

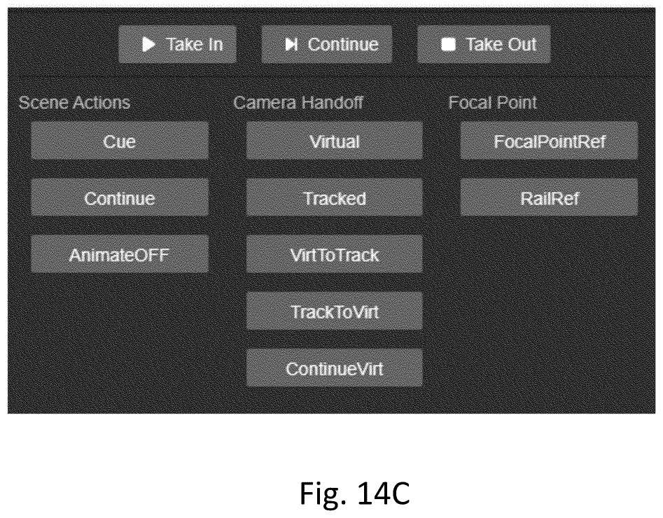

FIGS. 14A-14C illustrate different control interfaces of the present system according to an exemplary embodiment. FIG. 14A illustrates a camera placement and location interface. FIG. 14B illustrates a rail manager interface that allows users to set parameters relating to rails. FIG. 14C is an interface that allows for different actions or include scene actions, as well as focal point adjustment, and camera transitions between the virtual and physical camera. As shown in FIG. 14C, a user can switch to a virtual camera, switch to a tracked (physical) camera, transition from the virtual to physical camera, and transition from the physical to the virtual camera. The user can also select “ContinueVirt” which can move the current viewpoint from one virtual camera pathway to a different virtual camera pathway.

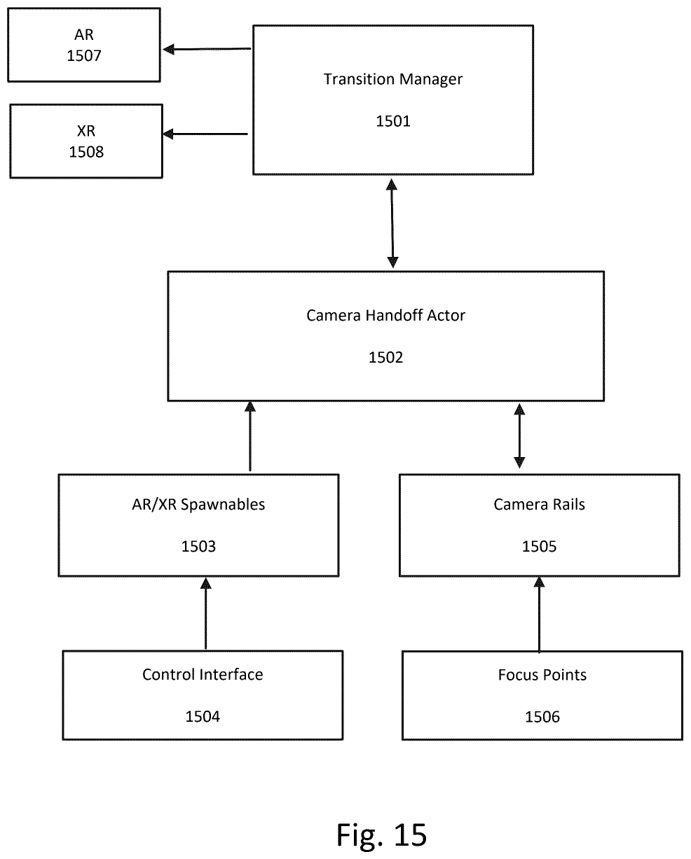

FIG. 15 illustrates a workflow diagram of the rail system and transitions between physical and virtual cameras. The transition manager 1501 provides the core logic/software routines for AR and XR functionality and controls transitions between physical and virtual camera systems. The transition manager 1501 generates the AR 1507 and XR 1508 outputs, such as in Stype®, for use in generating the view of the AR environment. (Stype® is a brand name for a high-precision camera tracking system (especially the Stype kit) used in conjunction with virtual graphics systems like Unreal Engine®, Vizrt®, Zero Density®, etc. It provides real-time positional data (like XYZ location, pan, tilt, zoom, focus) of a camera so that virtual elements (e.g., CGI sets, graphics) can move realistically and believably in sync with the real camera.) The camera handoff actor 1502 is a cinematic camera object that interfaces with the rail system and provides control handles for AR and/or XR dynamic content scenes. The AR/XR spawnables 1503 are templated scenes with controls built in for operators to execute virtual handoffs. The camera rails 1505, discussed previously, are predetermined paths with speed/easing information that provide paths between different parts of the virtual environment, such as rooms or other points of interest. The control interface 1504 is used to interface with the AR/XR spawnables 1503. Additionally, the focus points 1506 are virtual targets for camera rotation.

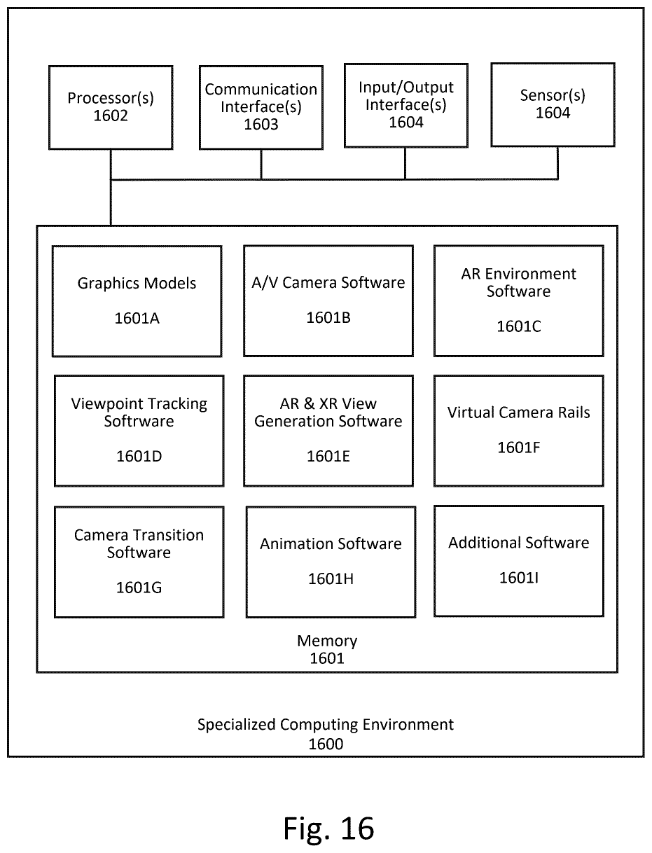

One or more of the above-described techniques can be implemented in or involve one or more special-purpose computer systems having computer-readable instructions loaded thereon that enable the computer system to implement the above-described techniques. FIG. 16 illustrates an example of a specialized computing environment 1600 used to perform the above-described methods and implement the above-described systems.

With reference to FIG. 16, the computing environment 1600 includes at least one processing unit/controller 1602 and memory 1601. The processing unit 1602 executes computer-executable instructions and can be a real or a virtual processor. In a multi-processing system, multiple processing units execute computer-executable instructions to increase processing power. The memory 1601 can be volatile memory (e.g., registers, cache, RAM), non-volatile memory (e.g., ROM, EEPROM, flash memory, etc.), or some combination of the two. The memory 1601 can store software implementing the above-described techniques, including graphics models 1601A, A/V camera software 1601B, AR environment generation software 1601C, viewpoint tracking software 1601D, AR & XR view generation software 1601E, virtual camera rails 1601F, camera transition software 1601G, animation software 1601H, and/or additional software 1601I.

All of the software stored within memory 1601 can be stored as computer-readable instructions, that when executed by one or more processors 1602, cause the processors to perform the functionality described with respect to FIGS. 1-15.

Processor(s) 1602 execute computer-executable instructions and can be a real or virtual processors. In a multi-processing system, multiple processors or multicore processors can be used to execute computer-executable instructions to increase processing power and/or to execute certain software in parallel.

Specialized computing environment 1600 additionally includes a communication interface 1603, such as a network interface, which is used to communicate with devices, applications, or processes on a computer network or computing system, collect data from devices on a network, such as a broadcast production network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 1600 further includes input and output interfaces 1604 that allow users to provide input to the system to set parameters, to edit data stored in memory 1601, or to perform other administrative functions.

An interconnection mechanism (shown as a solid line in FIG. 16), such as a bus, controller, or network interconnects the components of the specialized computing environment 1600.

Input and output interfaces 1604 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 1600.

Specialized computing environment 1600 can additionally utilize removable or non-removable storage, such as magnetic disks, magnetic tapes or cassettes, CD-ROMs, CD-RWs, DVDs, USB drives, or any other medium which can be used to store information and which can be accessed within the specialized computing environment 1600.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the present disclosure and equivalents thereto.

What is claimed is:

1. A method executed by one or more computing devices configured for generating an output view of an augmented reality environment during a transition between virtual and physical cameras, the method comprising:
providing a physical film set;
providing one or more audiovisual feeds of the physical film set captured by one or more physical cameras;
providing the one or more computing devices configured to generate the augmented reality environment;
generating, by the one or more computing devices, one or more three-dimensional graphics model of a virtual film set, where the virtual film set includes at least a location representation of the physical film set and the one or more physical cameras;
generating, by the one or more computing devices, one or more virtual feeds of the virtual film set captured by one or more virtual cameras;
establishing, for the one or more virtual cameras, at least one virtual camera pathway in the one or more three-dimensional graphic model that passes at or near at least one of the location representations of the one or more physical cameras;
generating, by the one or more computing devices, a transition point where the at least one virtual camera pathway passes at or near the location representation of the at least one of the one or more physical cameras;
establishing and transmitting spatial coordinates and orientation vectors of the one or more physical cameras to the one or more computing devices;
establishing and transmitting spatial coordinates and orientation vectors of the one or more virtual cameras along the at least one virtual camera pathway to the one or more computing devices;
synchronizing, by the one or more computing devices, the spatial coordinates and orientation vectors of the one or more virtual cameras to the one or more physical cameras at the transition point;
generating, by the one or more computing devices, a current viewpoint location within the augmented reality environment, where the current viewpoint location corresponds to a physical location of the one or more physical cameras and/or a virtual location of the one or more virtual cameras along the at least one virtual camera pathway;
sending a transition instruction, by a command, to the one or more computing devices to transition the current viewpoint location from the one or more physical cameras to the one or more virtual cameras at the transition point, or, from the one or more virtual cameras to the one or more physical cameras at the transition point;
generating and transmitting, by the one or more computing devices, the output view of the augmented reality environment based on the current viewpoint location including the transition point.

2. The method of claim 1, wherein the physical film set comprises one or more light emitting diode (LED) panels and wherein the one more LED panels are configured to output a portion of the virtual feed based at least in part on the current viewpoint location of the one or more virtual cameras when the current viewpoint location is not at the transition point.

3. The method of claim 1, wherein the one or more LED panel is disposed at an end of the physical film set.

4. The method of claim 1, wherein the physical film set includes at least one physical object and wherein the one or more three-dimensional graphics model of a virtual film set includes a corresponding virtual object that matches the physical object.

5. The method of claim 1, wherein the command sending the transition instruction is by a human user.

6. The method of claim 1, wherein the command sending the transition instruction is by the one or more computing devices.

7. The method of claim 1, wherein the one or more computing devices include at least one processing unit and a memory, where the at least one processing unit is configured to execute computer-executable instructions and where the memory is volatile memory and/or non-volatile memory.

8. A method executed by one or more computing devices for generating a view of an augmented reality environment, the method comprising:
generating, by at least one of the one or more computing devices, an augmented reality (AR) environment based at least in part on one or more audiovisual feeds of a set captured by one or more physical cameras and one or more three-dimensional graphics models of a virtual environment;
tracking, by at least one of the one or more computing devices, a current viewpoint location within the AR environment, the current viewpoint location corresponding to one or more of: a physical location of a physical camera in the one or more physical cameras or a virtual location of a virtual camera in the virtual environment; and
generating, by at least one of the one or more computing devices, a view of the AR environment based at least in part on the current viewpoint location.

9. The method of claim 8, wherein the physical film set comprises one or more light emitting diode (LED) panels and wherein the one more LED panels are configured to output a portion of the virtual environment based at least in part on the current viewpoint location.

10. The method of claim 9, wherein the view of the AR scene comprises one or more physical objects in the set captured by the physical camera at the physical location and one or more virtual objects visible to the virtual camera at the virtual location in the virtual environment.

11. The method of claim 10, wherein the one or more physical objects comprise the one or more LED panels and wherein the one more LED panels are configured to output a portion of the virtual environment based at least in part on the current viewpoint location.

12. The method of claim 8, wherein the view of the AR scene comprises one or more one or more virtual objects visible to the virtual camera at the virtual location in the virtual environment.

13. The method of claim 8, further comprising: storing, by at least one of the one or more computing devices, one or more virtual camera pathways, each virtual camera pathway defining a path through at least a portion of the virtual environment.

14. The method of claim 13, further comprising: receiving, by at least one of the one or more computing devices, a selection of a virtual camera pathway in the one or more virtual camera pathways; and transitioning, by at least one of the one or more computing devices, the current viewpoint location within the AR scene through the path defined by the selected virtual camera pathway.

15. The method of claim 14, wherein the view of the AR scene is generated based on the virtual location of the virtual camera in the virtual environment when transitioning the current viewpoint location within the AR scene through the path defined by the selected virtual camera pathway.

16. The method of claim 13, further comprising: receiving, by at least one of the one or more computing devices, an instruction to transition from a virtual camera to a physical camera; determining, by at least one of the one or more computing devices, the current viewpoint location at termination of a virtual camera pathway; and selecting, by at least one of the one or more computing devices, a physical camera in the one or more physical cameras based at least in part on the current viewpoint location.

17. The method of claim 13, further comprising: receiving, by at least one of the one or more computing devices, an instruction to transition from a physical camera to a virtual camera; determining, by at least one of the one or more computing devices, the current viewpoint location based on a physical location of the physical camera; and selecting, by at least one of the one or more computing devices, a virtual camera pathway based at least in part on the current viewpoint location.

18. The method of claim 8, generating a view of the AR scene based at least in part on the current viewpoint location comprises one of: generating a view based on a portion of the virtual environment visible to the virtual camera; or generating a view based on output from at least one physical camera in the one or more physical cameras and a portion of the portion of the virtual environment visible to the virtual camera.

19. The method of claim 8, wherein the current viewpoint location comprises one or more spatial coordinates and one or more orientation vectors.

20. A method executed by one or more computing devices configured for generating an output view of an augmented reality environment during a transition between virtual and physical cameras, the method comprising:
providing a physical film set;
providing one or more audiovisual feeds of the physical film set captured by one or more physical cameras;
providing the one or more computing devices configured to generate the augmented reality environment, wherein the one or more computing devices include at least one processing unit and a memory, where the at least one processing unit is configured to execute computer-executable instructions and where the memory is volatile memory and/or non-volatile memory;
generating, by the one or more computing devices, one or more three-dimensional graphics model of a virtual film set, where the virtual film set includes at least a location representation of the physical film set and the one or more physical cameras;
wherein the physical film set includes at least one physical object and wherein the one or more three-dimensional graphics model of a virtual film set includes a corresponding virtual object that matches the physical object;
generating, by the one or more computing devices, one or more virtual feeds of the virtual film set captured by one or more virtual cameras;
establishing, for the one or more virtual cameras, at least one virtual camera pathway in the one or more three-dimensional graphic model that passes at or near at least one of the location representations of the one or more physical cameras;
generating, by the one or more computing devices, a transition point where the at least one virtual camera pathway passes at or near the location representation of the at least one of the one or more physical cameras;
establishing and transmitting spatial coordinates and orientation vectors of the one or more physical cameras to the one or more computing devices;
establishing and transmitting spatial coordinates and orientation vectors of the one or more virtual cameras along the at least one virtual camera pathway to the one or more computing devices;
synchronizing, by the one or more computing devices, the spatial coordinates and orientation vectors of the one or more virtual cameras to the one or more physical cameras at the transition point;
generating, by the one or more computing devices, a current viewpoint location within the augmented reality environment, where the current viewpoint location corresponds to a physical location of the one or more physical cameras and/or a virtual location of the one or more virtual cameras along the at least one virtual camera pathway;
sending a transition instruction, by a command, to the one or more computing devices to transition the current viewpoint location from the one or more physical cameras to the one or more virtual cameras at the transition point, or, from the one or more virtual cameras to the one or more physical cameras at the transition point;
wherein the command sending the transition instruction is by a human user or by the one or more computing devices;
generating and transmitting, by the one or more computing devices, the output view of the augmented reality environment based on the current viewpoint location including the transition point;
wherein the physical film set comprises one or more light emitting diode (LED) panels and wherein the one more LED panels are configured to output a portion of the virtual feed based at least in part on the current viewpoint location of the one or more virtual cameras when the current viewpoint location is not at the transition point.
